(19) United States
(12) Patent Application Publication
(10) Pub. No.: US 2005/0080711 A1
(43) Pub. Date: Apr. 14, 2005

(54) Multiple page display

(76) Inventor: Leong Fai Mah, Bridgewater, NJ (US)

Correspondence Address: Dickstein Shapiro Morin & Oshinsky LLP;41st Floor, 1177 Avenue of the Americas, New York, NY, 10036-2714, US

(21) Appl. No.: 10/839,355

(22) Filed: May 6, 2004

Related U.S. Application Data
(60) Provisional application No. 60/478,570, filed on Jun. 12, 2003.

(51) Int. Cl. G06F 17/60

(52) U.S. Cl. 705/37

(57) ABSTRACT

The invention provides a screen display for use by a trader trading in financial instruments, and also a method of displaying price panels on a screen display. The screen display comprises a trading grid, which in turn comprises a plurality of price panels for displaying currency pair prices, a rates panel for displaying best quoted prices, at least one deals panel for displaying deals made by the trader, and a plurality of transaction panels for displaying the status of financial instrument trades. The price panels are arranged on a plurality of active pages which can be selected for viewing independently of the other panels. A multipage tab panel is associated with all the pages for selected of the active pages.

### FIELD OF THE INVENTION

This invention relates to trader workstations and displays used with electronic trading systems, particularly those which trade financial instruments such as foreign exchange products.

### BACKGROUND OF THE INVENTION

A number of anonymous trading systems are known in the art. EP-A-0,399,850, EP-A-0,406,026 and EP-A-0,411,748 all assigned to Reuters Ltd disclose aspects of an automated matching system in which a host computer maintains a central database of bids and offers submitted by terminals connected to the host via a network. The host also maintains records of credit limits between each trading bank and the possible counterparties with which it is willing to trade. The host computer uses information in its central database to match bids and offers and buy and sell orders based on matching criteria which include counter party credit limits.

A trader's terminal will display a subset of the trading book, typically the best few bids and offers. These will be updated periodically to ensure that the trader sees the true state of the market.

Such systems may be used to carry out trades using financial instruments such as foreign exchange products. A typical display, such as that used by the EBS Spot system operated by EBS Dealing Resources, Inc of New York, allows a trader to view and trade anonymous prices for up to six currency pairs. Each currency pair occupies a price panel, and hence the display has a limit of six panels. The price display panels displays anonymous spot market prices, and consists of EBS best bid and offer, dealable best bid and offer, and dealable regular best bid and offer. In addition, the price panel contains the currency pair name, its big figures for bid and offer, price warning icons and the bid and offer buttons. These bid and offer buttons, when clicked, will bring up a quote panel to allow the trader to enter bids and offers for the currency pair of interest.

The disadvantage of this display system is that should a trader wish to access a new currency pair which is not one of the six selected for display at his terminal, he must sacrifice one of the other price panels to continue trading. Consequently, the trader will not be able to access information regarding market conditions for the lost currency pairs.

Consequently, there is a need to provide a screen display in which the trader can continue to access his original selection of currency pairs and price panels, whilst simultaneously being able to access new price panels for new currency pairs, and remaining aware of market conditions.

### SUMMARY OF THE INVENTION

The invention aims to address the problem outlined above and to meet the need identified.

The invention provides a screen display for use by a trader trading fungibles on an automated trading system, the screen display comprising: an active trading grid, comprising a plurality of price panels for prices of fungibles tradable on the system, the plurality of price panels being arranged as at least a first active page or price panels, and a second active page comprising at least one price panel; and a plurality of further panels for displaying other trade related information; wherein the trader is able to switch, independently of said plurality of further panels, between at least the first active page and the second active page.

The invention also provides a screen display for use by a trader trading fungibles on an automated trading system, the screen display comprising a trading grid having a plurality of price panels for displaying prices of fungibles being traded on the trading system; and a plurality of further panels for displaying other trade related information; wherein the purality of price panels form two or more active pages which are selectable, independently of said further panels, for viewing by the user through a multiple page tab on the display.

The invention further provides a method of displaying price panels on a display screen of a trader terminal of a trading system, the method comprising the steps of: displaying a first plurality of price panels on a first active page, the first active page having an associated multiple page tab; selecting the multiple page tab; and displaying a second plurality of price panels on a second active page, the multiple page tab also being associated with the second active page.

The invention still further provides a trader terminal for trading on a trading system, the trader terminal being rranged to send data to the system and receive data from the system relating to a plurality of fungibles being traded on the system, the trader terminal comprising: a display; and software for generating a display screen comprising an active trading grid having a plurality of price panels for displaying prices of fungibles received from the trading systems; and a plurality of further panels for displaying other trade related information received from the trading system, wherein the plurality of price panels are divided into at least two active pages of price panels, the software further enabling the user to switch between the active pages of price panels for viewing, independently of the further panels.

The invention still further provides a screen display for use by a trader trading fungibles on an automated trading system, the screen display comprising:an active trading grid, comprising a plurality of price panels for prices of fungibles tradable on the system, the plurality of price panels being arranged as at least a first active page or price panels, and a second active page comprising at least one price panel; and a plurality of further panels for displaying other trade related information; and switching means to allow the trader to switch, independently of said plurality of further panels, between at least the first active page and the second active page.

The invention yet further provides a computer readable medium, having a program stored thereon, which when executed on a trader terminal of a computerised trading system causes the terminal to perform the steps of: generating a display screen comprising an active trading grid having a plurality of price panels for displaying prices of fungibles received from trading systems; associating a multiple page tab with a first active page comprising a first plurality of price panels; associating said multiple page tab with a second active page comprising a second plurality of price panels; displaying the first active page; and displaying the second active page on selection of the multiple page tab.

Embodiments of the invention enable several pages of price panels to be displayed. The user may select a given page for display, however all of the price panels, both those on a displayed and non-displayed remain active. Preferably, each page is associated with a multipage tab by which the user can select a page of price panels for display.

The switching of price panels is independent of any of the other panels that make up the screen display.

Embodiments of the invention have the advantage that they greatly facilitate the trading of multiple currency pairs by a trader.

In one preferred embodiment of the invention, vocalisations of the trading data may be associated with one or more price panels. The trader will still hear the vocalisations even if the price panel is not one of those displayed to the user. A plurality of price panels may have vocalisations assigned to them. These may be on the same or different active pages.

### BRIEF DESCRIPTION OF THE DRAWINGS

The invention will now be described by way of example only, and with reference to the following drawings in which:

FIG. 1 shows an example screen shot of a display in accordance with the present invention; and

FIG. 2 shows a possible arrangement of currency pairs in the price panels of a display in accordance with the present invention.

### DETAILED DESCRIPTION OF A PREFERRED EMBODIMENT

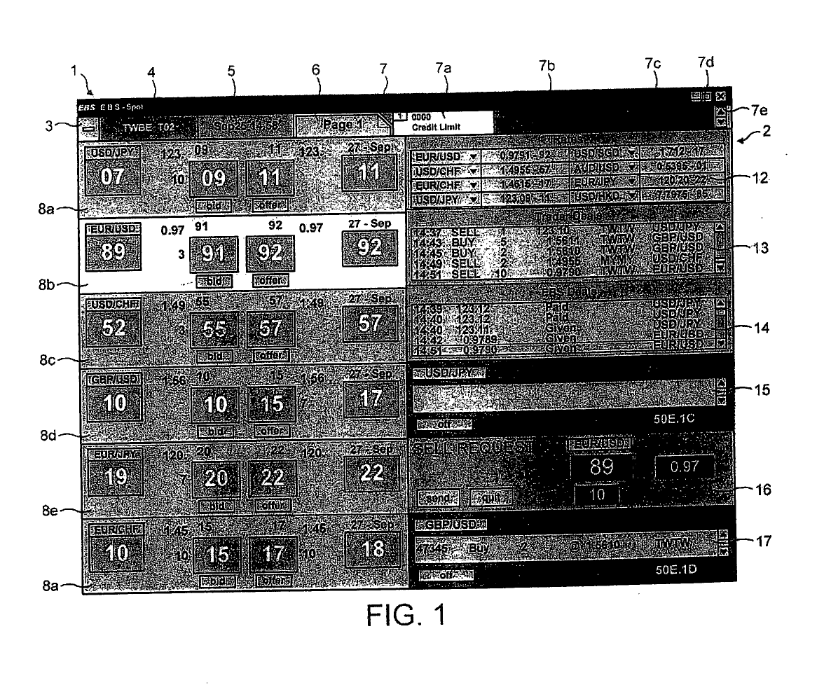

FIG. 1 shows an example screen shot of a screen display embodying the present invention. The display is displayed on the screen of a trader workstation trading on a computerised trading system.

The screen display 1 comprises several elements: a trading grid 2, a trading menu 3, a trading floor and trader identification panel 4, a date and time panel 5, a multiple page tab panel 6, and a silo 7.

The trading grid 2 is divided into six rows each having two equally sized rectangular panels. The left hand column comprises a price panel in which individual price panels 8a to 8f are displayed. Each of the price panels 8a to 8f represent a different instrument being traded on the system, in this case a different currency pair. Each currency pair is assembled at the trader's workstation. The price panel may contain between two and six panels. For example, if the price panel 8 is sized to hold two currency pairs, then it occupies two uppermost left-hand panels; three will need the three uppermost panels and so on. When a trader wishes to view the maximum number of currency pairs, then the trader will size the price panel to occupy all six of the left side column panels, as shown in FIG. 1, panels 8a to 8f.

Price panels 8a-8f allow a trader to group together currency pairs on up to nine price panel pages, one of which is displayed at any one time. Each price panel page allows trading in up to six pairs simultaneously. All dealable prices are pre-screened for credit and several prices are displayed:
EBS best price 9, which represents the best single price (Bid and Offer) in the market, regardless of credit,
Credit screened dealable prices 10, shown in the centre of the price panel, and which are the best Bid and Offer prices which have been pre-screened for credit and which the trading floor can deal,
Regular prices 11 are also shown either side of the best dealable price.

A size indicator (boa) may be displayed next to the best dealable price if the size available is less than at the regular amount. Various prices may be highlighted, by being displayed in a different font colour, in this example the EBS best price, which is shown in red.

The right-hand column houses six further panels; the rates panel 12, the trader deals panel 13, the EBS deals panel 14, and three transaction panels, 15, 16 and 17.

The rates panel 12 displays the best quoted prices in real time, and gives a continuous and comprehensive view of the electronic broking market.

The trader deals panel 13 shows deals completed by a trader, listed in time order. Deals done as a Price Maker are shown in a different font colour to deals done as a Price Taker. In this example, Price Maker deals are shown in black whilst Price Taker deals are shown in red.

The EBS deals panel 14 shows deals executed over the EBS network. Traders can chose to view single of multiple currency pairs.

The transaction panels 15 and 17 are bid transaction panels, for example, bid, offer, buy and sell transaction panels, which allow order details to be adjusted prior to submission. Panel 16 is the request panel, for example showing buy request, sell request, and bid/offer request panels. In FIG. 1, it is shown as a sell request panel. Transaction status panels allow orders to be tracked throughout the deal completion process. A trader will be shown the request panel 16 initially, and once an order has been submitted, the corresponding transaction panel 15 or 17 will be shown.

One advantage of the screen display embodying the present invention is that it is possible for the trader to assign various keys on the numeric keypad or keyboard as well as various voices to perform certain tasks. This is done via the trading menu 3.

The trading menu 3 is located at the uppermost left-hand corner of the screen display 1. The trading menu 3 provides the trader access to additional features of the EBS Spot trading system. Some of these features include:
Basic Parameters: allows the trader to customise the trading features such as audio alerts, voice channels, trading timers, work-the-balance and any other available trading behaviours which may be customised;
Currency Pair Defaults: allows the trader to carry out currency pair operations such as activate currency pairs, initialise the activated currency pairs with trade sizes, tracking, auto spread values and voices;
Screen Setup: allows the trader to customise layout of the screen display, such as the number of price panels, the currency pairs in the price panels, the keypad navigation, and the type and size of the informational panels, (Rates, Trader Deals, EBS Deals, Overview, News).

A trading floor and trader identification panel 4 is provided at the top of the screen display 1, immediately on the right of the trading menu 3. This panel displays the current trading session information comprising the trading floor identification and the trader's identity.

A date and time panel 5 is provided at the top of the screen display 1, on the right-hand side of the trading floor and trader identification panel 4. This displays the current GMT date and time of the EBS Spot system.

The multipage tab panel 6 is at the top of the screen display 1 and immediately to the right of the date and time panel S. This displays the page number of the current active page of price panels. In this embodiment, there are nine pages of price panels, numbered 1 to 9, although other numbers may be adopted depending on the number of currency pairs or other instruments supported by the system.

The mulitpage tab 6 also functions as a cycling control for price panel page cycling. A left mouse button double click will cycle though the non-blank price panel pages (these are pages containing at least one currency pair), and the right mouse button allows each page to be cycled through sequentially, whether the page is blank or not. For example, if only pages 1 and 5 contain price information then using the left mouse button will display each page alternately. However, using the right mouse button key will also scroll through the blank pages 2 to 4 and 6 to 9.

The keypad's minus (−) key also functions in the same manner as the left mouse button double-click. Pressing the minus key and any numeric (1-9) key simultaneously results in a direct price panel page selection, where the numeric key pressed is that of the desired number of the page to be displayed.

The silo 7 is at the top of the display, and immediately to the right of the multiple page tab 6. This comprises three silo panels, 7a, 7b and 7c, arranged horizontally, which display other pertinent information. A silo message counter 7d and a silo message scroll bar 7e to scroll additional silo messages into view are also displayed. The three silo panels act as a sliding window to view any three consecutive silo messages.

Credit information in the form of pre-trade credit screening and warning panels, is displayed in the silo panels 7a, 7b and 7c, which are located on the right-hand side of the silo panel. These indicate whether a counterparty is approaching or has reached its pre-determined credit limit. A panel indicating that a counterparty is approaching a credit limit may be highlighted in yellow, for example, whereas one indicating that the counterparty has reached the credit limit may be highlighted in red. Access to this information allows the trader to minimise trading risk.

Traditional graphic user interfaces (GUI's) implement tabbed pages with all the pages of the same size stacking on top of one another, with the visible page being the uppermost page. Each page therefore has an associated visible tab, with all the tabs grouped together and placed on any one of the four sides of the vertically stacked pages.

The screen display 1 uses a single visible tab 6 to allow a trader to use multiple pages of price panels. Although the number of price panels per page can be adjusted, all pages have the same number of price panels.

The screen display 1 also allows traders to assign voices to currency pairs, and then to assign these currency pairs to any price panel page via the trading menu 3. There are several voices for the trader to choose from. The use of voices in dealing systems is described in detail in U.S. Pat. No. 5,806,050. In the present embodiment, the system will support a number of voices, for example 4, each being assigned to a fungible instrument, that is a currency pair in this embodiment. However, the currency pair does not have to be on a page that is visible to the user. Thus, in the example of FIG. 1, in which page 1 currency pairs are shown, a voice may be assigned to one currency pair on page 2, one on page 3, one on page 4 and one on page 5. The trader will hear market updates on those hidden currency pairs. In other words, the currency pairs are active even though they are hidden from view. This means that a trader can simultaneously trade up to 10 currency pairs: the six on view in the price panel and a further four to which voice has been assigned.

The display system 1 offers a range of benefits to the trader compared to traditional GUI's. For example, the display system allows the trader to trade in more currency pairs merely by switching between predefined pages, all of which remain active at any time. As described above, this page switching may be optimised to use a mouse, numeric keypad or keyboard.

It will be appreciated that the price panel pages are changeable independently of the rest of the panels of the display so that the user can change the page of price panels being displayed without interrupting the information displayed in the other panels.

Each price panel page is a virtual page, and may be mapped to a logical containment window to enable price panel pages to be switched independently. By making only one page visible at any one time, the net result is that pages are effectively paged in and out of the display. Alternatively, the nine virtual pages of screen information are contained in one logical containment window. When one active price panel page is chose, the screen information for this virtual page is moved into view in the logical containment window, and the remaining screen information of the remaining price panel windows (which have not been chosen for viewing) are moved out of view.

The screen display 1 also allows the trader's active orders to be seen at all times, even when switching between pages. The trader can therefore monitor the active orders, and take immediate action when market conditions change. For example, if the trader has a bid and an offer for Euros and US Dollars (EUR/USD) in the market, and then switches to another page, then the trader's bid and offer for EUR/USD is still visible. This visual feedback gives the trader a sense of security and control over his own orders.

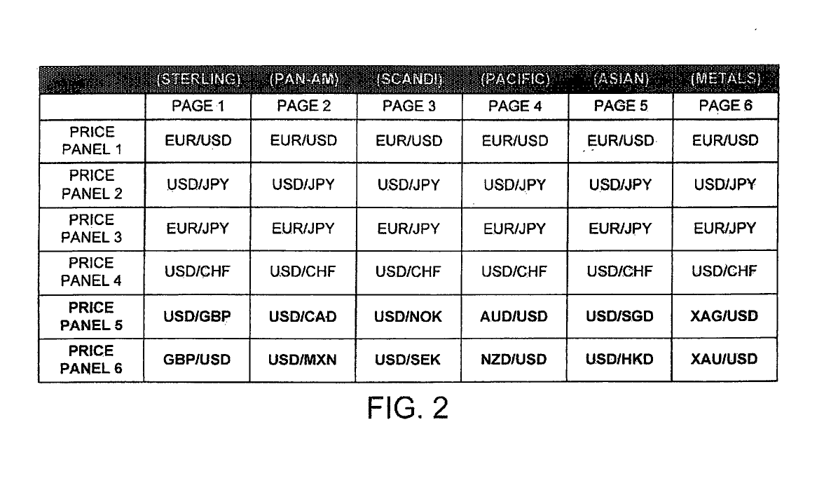

FIG. 2 shows an example of how currency pairs may be grouped. This allows regional currency pairs to be grouped more efficiently. For example, the trader may use page 1 for EUR currency pairs, page 2 for USD currency pairs, page 3 for Scandi currency pairs, page 4 for Asia-Pacific currency pairs and so on.

The pages may also be set up with the same frequently traded currency pairs in the same price panels. For example, EUR/USD, USD/JPY and EUR/JPY, may displayed in the first three price panels, and the remaining three price panels per page used to view different combinations of currency pairs.

Since the screen display 1 allows various voices to be assigned to currency pairs, it is also possible for the trade to hear the market prices of currency pairs which are placed in pages other than that which is visible. Considering FIG. 2, if the current visible page is page 2, then if voices are assigned to the Asian currency pairs USD/SGD and USD/HKD, then the trader will hear the market pries for these currency pairs, even though they are placed on page 5 and not currently visible.

The invention therefore allows the trader access to a greater range of information, whilst providing a level of security and control by providing order and credit information visible at all times, which is not possible with traditional GUI displays.

It should be understood that various other modifications are possible and will occur to those skilled in the art without departing from the spirit and scope of the invention which is defined by the following claims.

1. A screen display for use by a trader trading fungibles on an automated trading system, the screen display comprising:
an active trading grid, comprising
a plurality of price panels for prices of fungibles tradable on the system, the plurality of price panels being arranged as at least a first active page or price panels, and a second active page comprising at least one price panel; and
a plurality of further panels for displaying other trade related information; wherein the trader is able to switch, independently of said plurality of further panels, between at least the first active page and the second active page.

2. The screen display of claim 1, wherein the plurality of price panels on the first active page and the at least one price panel on the second page comprise at least one common fungible.

3. The screen display of claim 1, wherein the plurality of price panels on the first page and the at least one price panel on the second price panel do not comprise a common fungible.

4. The screen display of claim 1, further comprising;
a multiple page tab panel for switching between the first active page of price panels and the second active page of at least one price panel.

5. The screen display of claim 4, comprising a trading menu providing access to:
basic parameters to allow trading features to be customised;
currency pair defaults to allow currency pair operations; and
a screen set up to allow the layout of the display to be customised.

6. A screen display according to claim 1 comprising a voice menu for assigning vocalisations of trading data to at least one of the fungibles tradable on the system.

7. A screen display according to claim 6, wherein the fungible to which the vocalisation is assigned is not on an active page of price panels displayed by the display.

8. A screen display according to claim 1, comprising a voice menu for assigning vocalisations of trading data to a plurality of fungibles tradable on the system and arranged on more than one active screen of price panels.

9. The screen display of claim 4, wherein the multiple page tab panel identifies the visible active page.

10. The screen display of claim 9, wherein the multiple page tab panel allows the trader to switch between active pages.

11. A screen display according to claim 1, comprising at least one further active page having a plurality of price panels, and a page selector for selecting one of said first active page, said second active page and said at least one further active page of price panels for display.

12. A screen display according to claim 1, wherein the number of price panels displayed on an active page is variable by the user.

13. A screen display according to claim 1, wherein the price panels are sizeable.

14. A screen display according to claim 1, wherein the fungibles are financial instruments.

15. A screen display according to claim 14, wherein the financial instruments are foreign exchange products.

16. A screen display according to claim 15, wherein the foreign exchange products are currency pairs.

17. A screen display for use by a trader trading fungibles on an automated trading system, the screen display comprising a trading grid having a plurality of price panels for displaying prices of fungibles being traded on the trading system; and a
plurality of further panels for displaying other trade related information;
wherein the plurality of price panels form two or more active pages which are selectable, independently of said further panels, for viewing by the user through a multiple page tab on the display.

18. The screen display of claim 11, wherein the multiple page tab panel allows the trader to switch between said two or more active pages.

19. A method of displaying price panels on a display screen of a trader terminal of a trading system, the method comprising the steps of:
displaying a first plurality of price panels on a first active page, the first active page having an associated multiple page tab;
selecting the multiple page tab; and
displaying a second plurality of price panels on a second active page, the multiple page tab also being associated with the second active page.

20. The method of claim 19, wherein the multiple page tab is selected using one of a computer mouse, a numerical keypad or a computer keyboard.

21. The method of claim 20, wherein more than two active pages may be displayed and wherein each page may be selected directly.

22. The method of claim 20, wherein more than two active pages may be displayed and each page may be selected sequentially.

23. A trader terminal for trading on a trading system, the trader terminal being arranged to send data to the system and receive data from the system relating to a plurality of fungibles being traded on the system, the trader terminal comprising:
a display; and
software for generating a display screen comprising an active trading grid having a plurality of price panels for displaying prices of fungibles received from the trading systems; and
a plurality of further panels for displaying other trade related information received from the trading system, wherein the plurality of price panels are divided into at least two active pages of price panels, the software further enabling the user to switch between the active pages of price panels for viewing, independently of the further panels.

24. A trader terminal according to claim 23, wherein said software further enables a user to assign vocalisations of trade related data received from said trading system to at least one fungible displayed in a price panel, the vocalisations being provided to the user irrespective of whether the price panel is part of the active screen being displayed.

25. A trader terminal according to claim 23, wherein the software further generates a multipage tab shared by the active pages to enable a user to select an active page of price panels for viewing.

26. A screen display for use by a trader trading fungibles on an automated trading system, the screen display comprising:
an active trading grid, comprising
a plurality of price panels for prices of fungibles tradable on the system, the plurality of price panels being arranged as at least a first active page or price panels, and a second active page comprising at least one price panel; and
a plurality of further panels for displaying other trade related information; and
switching means to allow the trader to switch, independently of said plurality of further panels, between at least the first active page and the second active page.

27. The screen display of claim 26, wherein the plurality of price panels on the first active page and the at least one price panel on the second page comprise at least one common fungible.

28. The screen display of claim 26, wherein the plurality of price panels on the first page and the at least one price panel on the second price panel do not comprise a common fungible.

29. The screen display of claim 26, wherein the means for switching between at least the first active page and the second active page comprises;
a multiple page tab panel for switching between the first active page of price panels and the second active page of at least one price panel.

30. The screen display of claim 29, comprising a trading menu providing access to:
basic parameters to allow trading features to be customised;
currency pair defaults to allow currency pair operations; and
a screen set up to allow the layout of the display to be customised.

31. A screen display according to claim 26 comprising a voice menu for assigning vocalisations of trading data to at least one of the fungibles tradable on the system.

32. A screen display according to claim 31, wherein the fungible to which the vocalisation is assigned is not on an active page of price panels displayed by the display.

33. A screen display according to claim 26, comprising a voice menu for assigning vocalisations of trading data to a plurality of fungibles tradable on the system and arranged on more than one active screen of price panels.

34. The screen display of claim 29, wherein the multiple page tab panel identifies the visible active page.

35. The screen display of claim 34, wherein the multiple page tab panel allows the trader to switch between active pages.

36. A screen display according to claim 26, comprising at least one further active page having a plurality of price panels, and a page selector for selecting one of said first active page, said second active page and said at least one further active page of price panels for display.

37. A screen display according to claim 26, wherein the number of price panels displayed on an active page is variable by the user.

38. A screen display according to claim 26, wherein the price panels are sizeable.

39. A screen display according to claim 26, wherein the fungibles are financial instruments.

40. A screen display according to claim 39, wherein the financial instruments are foreign exchange products.

41. A screen display according to claim 40, wherein the foreign exchange products are currency pairs.

42. A computer readable medium, having a program stored thereon, which when executed on a trader terminal of a computerised trading system causes the terminal to perform the steps of:
generating a display screen comprising an active trading grid having a plurality of price panels for displaying prices of fungibles received from trading systems;
associating a multiple page tab with a first active page comprising a first plurality of price panels;
associating said multiple page tab with a second active page comprising a second plurality of price panels;
displaying the first active page; and
displaying the second active page on selection of the multiple page tab.
